(19) United States
(12) Patent Application Publication
(10) Pub. No.: US 2012/0305738 A1
(43) Pub. Date: Dec. 6, 2012

(54) PORTABLE APPARATUS FOR HOLDING POLE-LIKE OBJECTS

(76) Inventor: Brandon Gramse, La Mesa, CA (US)

(21) Appl. No.: 13/152,306

(22) Filed: Jun. 3, 2011

(51) Int. Cl. F16M 13/02; F16M 13/00

(52) U.S. Cl. 248/534

(57) ABSTRACT

A portable apparatus for holding one or more pole-like objects, in particular, billiard cues, is provided. The apparatus prevents the pole-like objects from accidently falling out, if they are unintentionally bumped. The apparatus can be mounted on a piece of furniture, e.g. a tabletop. The apparatus may comprise: a grip having an E-shape, the grip comprising an opening and a plurality of caves, each of the plurality of caves being configured to receive the one or more pole-shaped objects, the opening being made such that the grip comprises one or more protrusions in the place where the opening of the grip is, a bracket having an L-shaped form, the bracket comprising one or more notches arranged on one end and a threaded circular opening arranged through another end, a threaded circular rod, the rod being configured to be twisted in the opening of the bracket, wherein the bracket is configured to be embedded into the opening of the grip so that said one or more protrusions is selectively inserted into said one or more notches of the bracket to provide good clutch/coupling between the grip and the bracket.

### TECHNICAL FIELD

The present disclosure relates generally to devices assigned for holding different objects, and more specifically, to a portable apparatus for holding pole-like objects.

### BACKGROUND

The approaches described in this section could be pursued but are not necessarily approaches that have been previously conceived or pursued. Therefore, unless otherwise indicated, it should not be assumed that any of the approaches described in this section qualify as prior art merely by virtue of their inclusion in this section.

Owners of expensive, fragile or delicate pole-like objects, such as pool/billiard cues, guns, fishing rods, etc., usually wish to keep such objects in a safe place when they are not daily used in order to prevent the objects from any damage they can get, e.g., when they are accidentally dropped on the floor. Furthermore, some of the pole-like objects, such as painting brushes, are dirty so that they can soil other surrounding objects. In this case, it is also desirable to isolate such pole-like objects in a special place.

Nowadays the problem of holding the pole-like objects is solved by using different devices assigned for this purpose. The operation principle of such devices consists in confining the pole-like objects such that they are fixed in a particular position. However, these devices are often permanently installed at a location near where the pole-like objects are typically used or stored for lengthy periods of time. Consequently, when the pole-like objects are actually used in a location remote from such permanently-installed holding devices, such permanently-installed holding device fail to adequately serve containment needs for the pole-like objects.

Additionally, different holding devices known from the prior art are often implemented as clips which do not provide reliable holding of the pole-like objects. Namely, the pole-like objects fixed in such clip-like devices can easily jump out of such clip-like devices when they are accidently hit by legs, hands, or any other objects. This can lead to any damage of both the pole-like objects and other objects they will fall on.

### SUMMARY

The following presents a simplified summary of one or more embodiments in order to provide a basic understanding to the reader of such embodiments. This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In accordance with one or more embodiments and the corresponding disclosure thereof, various aspects are described herein in connection with an apparatus for holding pole-like objects. The apparatus can be easily mounted on a piece of furniture, e.g. a table-top or a table-like surface. The apparatus is designed to hold pole-like objects and prevent them from accidently falling out, if they are unintentionally bumped.

According to one embodiment, an apparatus for holding one or more pole-like objects is provided. The apparatus may comprise: a grip having an E-shape, the grip comprising an opening and a plurality of caves, each of the plurality of caves being configured to receive the one or more pole-shaped objects, the opening being made such that the grip comprises one or more protrusions in the place where the opening of the grip is, a bracket having an L-shaped form, the bracket comprising one or more notches arranged on one end and a threaded circular opening arranged through another end, a threaded circular rod, the rod being configured to be twisted in the opening of the bracket, wherein the bracket is configured to be embedded into the opening of the grip so that said one or more protrusions is selectively inserted into said one or more notches of the bracket to provide good clutch between the grip and the bracket.

In one example, each of the plurality of caves in the grip may have a C-shape. In yet another embodiment, each of the plurality of C-shaped caves may have an oblong C-shape. The bracket and the rod can be made of metal, plastic materials, rubber, polymer materials, wood components, or combinations thereof. The one or more protrusions may have the oblong shape conforming to the form of the one or more notches. The rod may further comprise a hook. The rod may further comprise a hand grip for hand-operated rotation of the rod when twisting in or out of the bracket. The rod may further comprise a cap. The cap can be detachable. The cap can be made of metal, plastic materials, rubber, polymer materials, wood components, or combinations thereof. The cap can be provided with a circular thread cave. The one or more pole-shaped objects may comprise one or more of a pool/billiards cue, a gun, a rifle, garden accessories, a mop, a painting brush.

The apparatus may be configured to be mounted on a rigid planar structure, wherein the rigid planar structure may comprise one or more of a table, a tabletop, a bar, a rack, a furniture, and a board. The crossed shape of the grip opening can be similar to the crossed shape of the bracket. The crossed shape of the bracket and the grip opening can be quadrangular. The apparatus may further comprise a resilient strip attached to the side surface of the grip.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

Embodiments are illustrated by way of example and not limitation in the figures of the accompanying drawings, in which like references indicate similar elements and in which:

FIG. 1 illustrates a prospective view of a portable apparatus for holding one or more pole-like objects according to an exemplary embodiment;

FIG. 2 illustrates a front view of main constructive elements of the apparatus shown in FIG. 1 according to an exemplary embodiment.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspects may be practiced without these specific details.

Aspects are disclosed in the following description and related drawings directed to specific embodiments. Alternate embodiments may be devised without departing from the disclosed scope. Additionally, well-known elements will not be described in detail or will be omitted so as not to obscure the relevant details.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The word “exemplary” is used herein to mean “serving as an example, instance, or illustration”. Any embodiment described herein as “exemplary” is not necessarily to be construed as preferred or advantageous over other embodiments. Likewise, the term “embodiments” does not require that all embodiments include the discussed feature, advantage or mode of operation.

According to one or more embodiments disclosed herein, a portable apparatus for holding pole-like objects is provided. The apparatus is designed to hold pole-like objects in a substantially vertical position, and the apparatus prevents the held pole-like objects from accidently falling out, if they are unintentionally bumped. The apparatus can be mounted on a piece of furniture, e.g. a tabletop. Different embodiments imply the use of the apparatus to hold pool/billiard cues, guns, rifles, garden accessories, mops, painting brushes, etc. For simplicity, the embodiments given below imply the use of the apparatus as a holder for billiards cues. Other embodiments can be implemented in the same or similar manner.

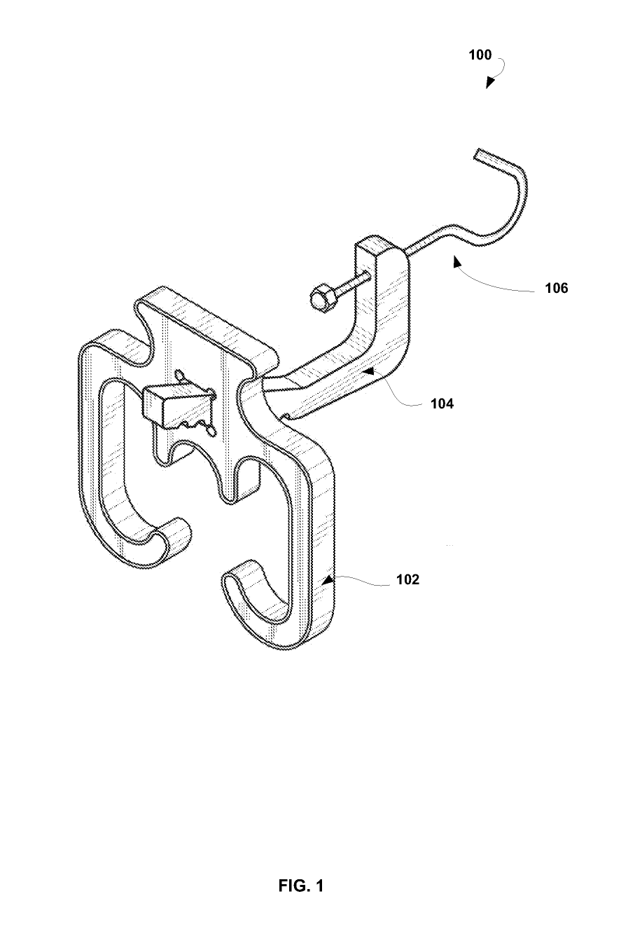

Referring now to the drawings, FIG. 1 illustrates a perspective view of an apparatus 100 for holding billiard cues in accordance with an exemplary embodiment. The apparatus 100 comprises a grip 102, a bracket 104 and a threaded circular rod 106. As shown in FIG. 1, the rod 106 is twisted in the bracket 104 which is in turn detachably embedded into the grip 102.

As used hereinafter, the term “grip” relates to an article for grasping or holding something. According to the present disclosure, the grip 102 is assigned to hold pole-like objects, such as billiard cues. The grip 102 can be made of metal, plastic materials, rubber, polymer materials, wood components, or combinations thereof.

As also used hereinafter, the term “bracket” refers to an article used as a support for something. In this case, the bracket 104 is applied to support the grip 102. The bracket 104 can be also made of metal, plastic materials, rubber, polymer materials, wood components, or combinations thereof.

As used hereinafter, the term “rod” implies a thin straight bar having a thread on one end or both ends. Similarly, the rod 106 can be made of metal, plastic materials, rubber, polymer materials, wood components, or combinations thereof.

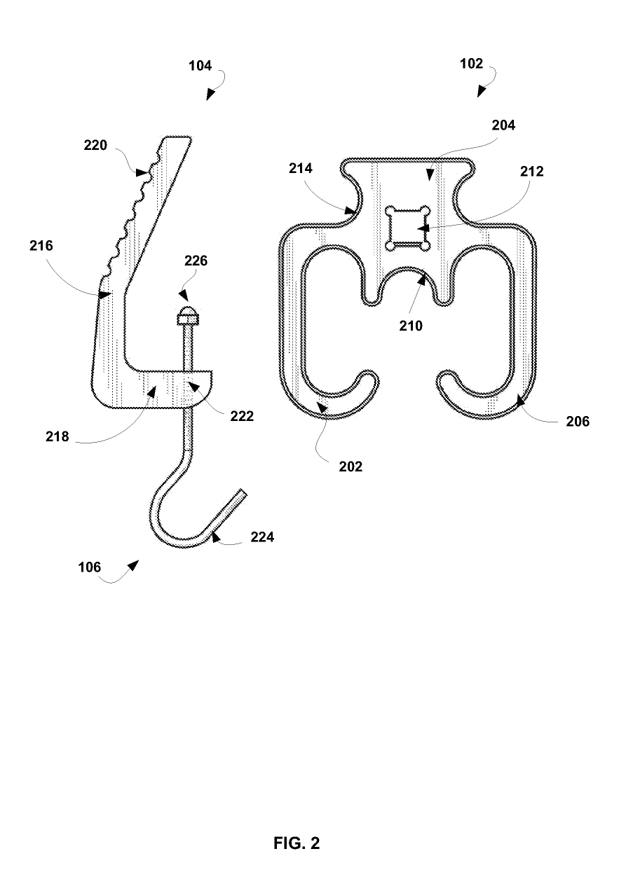

The detailed description of the grip 102, the bracket 104 and the rod 106 will be given below with reference to FIG. 2.

As a holder for the billiard cues, the apparatus 100 can be mounted at the edge of any tabletop (or any other table-like surface) such that the tabletop is placed between the grip 102 and the bracket 104. In this case, the rod 106 twisted in the bracket 104 is used as a presser to the bottom surface of the tabletop in order to fix the apparatus 100 at the edge of the table. If a player wants to carry the apparatus 100 to the other edge of the table, he/she should just untwist the rod 106 and release the apparatus 100.

The apparatus 100 can also be installed on any other objects, such as pieces of furniture, pipes, counters, bars, sills, or the like.

FIG. 2 illustrates a front view of all constructive elements of the apparatus 100, namely the grip 102 and the bracket 104 having the rod 106 twisted in it.

As shown, the grip 102 is E-shaped. The E-shaped grip 102 can be mentally divided into three parts, namely a left part 202, a middle part 204 and a right part 206. The left part 202 is the mirror image of the right part 206. Both of the left part 202 and the right part 206 have two identical C-shaped caves 208. Although each of the caves 208 has a C-shape, it should be apparent for those skilled in the art that they can be made in other different forms, depending on the form of pole-like objects. In the shown case, the C-shape is more convenient to receive one or more billiard cues. In one exemplary embodiment, the C-shape of the caves 208 can be oblong. The middle part 204 of the grip 102 comprises a C-shaped cave 210 and an opening 212. The C-shaped cave 210 can be also configured to receive one or more billiard cues. The opening 212 should have a form which would be applicable for the bracket 104 to be embedded therein. In this shown example, such a form is a square form. Those skilled in the art would understand that any other forms of the opening 212 can be used depending on the form of the bracket 104. Additionally, the opening 212 is made such that the grip 102 comprises one or more protrusions (not shown) in the place where the opening 212 is. The importance of the protrusions will be explained below.

In some example embodiments, the middle part 204 may have two additional caves 214. These caves can be also made in different forms. Since the apparatus 100 is a holder for billiard cues, the caves 214 are C-shaped similar to the caves 208 and the cave 210. Although these caves do not provide the same efficiency for holding billiard cues as the caves 208 and the cave 210 taken together do, they can be used in the cases when each of the caves 208 and the cave 210 is already occupied by billiards cues. A player can just abut his/her cue on the grip 102 by placing it in one of the caves 214.

According to yet another example embodiment, the grip 102 can be provided with a resilient strip (not shown). Such a resilient strip can be made of rubber, polymer, synthetic, semi-synthetic materials, or the like. The strip can be attached to the side surface or inner surface of the grip to prevent damages of the holding object.

As for the bracket 104, it may have an L-shape according to various embodiments. The L-shaped bracket 104 can be mentally divided into two parts, namely a long arm 216 and a short arm 218. In one example, the long arm 216 may be slightly bended in the direction to the short arm 218. The side of the long arm 216 which is outward with respect to the short arm 218 comprises multiple notches 220. The notches 220 are made such that they can be inserted into the protrusions, thereby providing good clutch between the grip 102 and the bracket 104. The short arm 218 comprises a threaded circular opening 222 which the rod 106 can be twisted in and out of.

In one example, the rod 106 is made as a screw-bolt with a hook 224 on its end. The hook 224 facilitates twisting the rod 106 in or out of the bracket 104, and can be also used to hold different objects, such as keys, cloths, etc. Those skilled in the art would understand that the easy twisting of the rod 106 in or out of the bracket 106 can be achieved by other different forms of the rod end, e.g. the end can be bended perpendicular to the remaining of the rod 106. In yet another embodiment, the rod 106 can be provided with a hand grip instead of the hook 224.

In some embodiments, the rod 106 can be provided with a cap 226 which fits on its end passing through the opening 222 in the direction to the bended long arm 216 of the bracket 104. In this case, the cap 226 is used to increase the pressure area of the rod 106 on the surface of an object contained between the grip 102 and the short arm 218 of the bracket 104. As was mentioned above, such an object can represent the tabletop. By increasing the pressure area, the apparatus 100 stronger coupes to the tabletop, therefore providing more efficiency for holding billiard cues. Although FIG. 2 illustrates that the cap 226 has a rounded form, those skilled in the art should understand that the cap 226 can have any other forms, such as flat, cylindrical, pyramidal, etc. The material of cap 226 can include metal, plastic, synthetic materials, hard rubber, wood, etc. The cap 226 can be also made of metal, plastic materials, rubber, polymer materials, wood components, or combinations thereof. The cap 226 can be part of the rod 106 or a separate element attachable to the rod 106.

In one other example embodiment, the cap 226 can be provided with a thread circular cave. In this case, the cap 226 can be twisted on the rod 106.

Thus, the portable apparatus for holding one or more pole-like objects such as billiard cues is provided. The apparatus can be mounted at the edge of the tabletop such that the pole-like objects can be in the close proximity of its owner. The apparatus allows holding pole-like objects in a substantially vertical position, and the apparatus prevents the held pole-like objects from accidently falling out, if they are unintentionally bumped or hit. Other embodiments imply the use of the apparatus to hold guns, rifles, garden accessories, mops, painting brushes, etc.

Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. An apparatus for holding one or more pole-shaped objects, the apparatus comprising:
a grip having an E-shape, the grip comprising an opening and a plurality of caves, each of the plurality of caves being configured to receive the one or more pole-shaped objects, the opening being made such that the grip comprises one or more protrusions in the place where the opening of the grip is;
a bracket having an L-shaped form, the bracket comprising one or more notches arranged on one end and a threaded circular opening arranged through another end;
a threaded circular rod, the rod being configured to be twisted in the opening of the bracket;
wherein the bracket is configured to be embedded into the opening of the grip so that said one or more protrusions is selectively inserted into said one or more notches of the bracket to provide good clutch/coupling between the grip and the bracket.

2. The apparatus of claim 1, wherein each of the plurality of caves in the grip has a C-shape.

3. The apparatus of claim 2, wherein each of the plurality of C-shaped caves has an oblong C-shape.

4. The apparatus of claim 1, wherein the grip, the bracket and the rod are made of metal, plastic materials, rubber, polymer materials, wood components, or combinations thereof.

5. The apparatus of claim 1, wherein the one or more protrusions has the oblong shape conforming to the form of the one or more notches.

6. The apparatus of claim 1, wherein the rod further comprises a hook.

7. The apparatus of claim 1, wherein the rod further comprises a hand grip for hand-operated rotation of the rod when twisting in or out of the bracket.

8. The apparatus of claim 1, wherein the rod further comprises a cap.

9. The apparatus of claim 8, wherein the cap is detachable.

10. The apparatus of claim 8, wherein the cap is made of metal, plastic materials, rubber, polymer materials, wood components, or combinations thereof.

11. The apparatus of claim 8, wherein the cap is provided with a circular thread cave.

12. The apparatus of claim 1, wherein the one or more pole-shaped objects comprises one or more of a pool/billiards cue, a gun, a rifle, garden accessories, a mop, a painting brush.

13. The apparatus of claim 1, wherein the apparatus is configured to be mounted on a rigid planar structure, wherein the rigid planar structure comprises one or more of a table, a tabletop, a bar, a rack, a furniture, and a board.

14. The apparatus of claim 1, wherein the crossed shape of the grip opening is similar to the crossed shape of the bracket.

15. The apparatus of claim 15, wherein the crossed shape of the bracket and the grip opening is quadrangular.

16. The apparatus of claim 1, further comprising a resilient strip attached to the side surface of the grip.
